(19) United States
(12) Patent Application Publication
(10) Pub. No.: US 2010/0177606 A1
(43) Pub. Date: Jul. 15, 2010

(54) METHOD FOR IDENTIFING A LAYER NUMBER OF AN OPTICAL DISC

(75) Inventors: Chia-Hsing HSU, Taoyuan County (TW); Ming-Tsung Hsieh, Taoyuan County (TW); Yi-Long Hsiao, Taoyuan County (TW)

Correspondence Address: RABIN & Berdo, PC, 1101 14TH STREET, NW, SUITE 500, WASHINGTON, DC, 20005, US

(73) Assignee: QUANTA STORAGE INC., Taoyuan County (TW)

(21) Appl. No.: 12/683,324

(22) Filed: Jan. 6, 2010

(30) Foreign Application Priority Data
Jan. 9, 2009 (TW) 98100890

(51) Int. Cl. G11B 7/00

(52) U.S. Cl. 369/44.23; G9B/7

(57) ABSTRACT

A method for identifying a layer number of an optical disc is provided. Firstly, a SA value is adjusted to a standard SA value of each of two data layers in sequence. Next, focusing courses are performed so as to enable the focus point to pass through the optical disc. Then, maximum amplitudes of focusing error signals in the focusing courses are recorded. After that, whether the maximum amplitudes of the focusing error signals recorded in the focusing courses are equal is checked. If the maximum amplitudes are equal, the optical disc is identified as a double-layered disc. If the maximum amplitudes are not equal, the optical disc is identified as a single-layered disc.

This application claims the benefit of Taiwan application Serial No. 98100890, filed Jan. 9, 2009, the subject matter of which is incorporated herein by reference.

### BACKGROUND OF THE INVENTION

1. Field of the Invention

The invention relates in general to a method for identifying a layer number of an optical disc, and more particularly to a method for identifying a layer number of an optical disc adapted to an optical disk drive.

2. Description of the Related Art

As a pick-up head of an optical disk drive has small optical components such as an object lens, the material, formation, curved surfaces and smoothness of the small optical components are hard to control in the manufacturing process. Therefore, the brightness of the light beam is un-uniform to cause spherical aberration (SA) easily, so that the focusing quality of the light beam is reduced to affect the identification of the marks.

As indicated in FIG. 1, a spherical aberration correcting system disclosed in U.S. Pat. No. 6,756,574 is shown. A laser device 2 of a pick-up head 1 emits a laser beam. The laser beam passes through several optical components 3, a spherical aberration correcting unit 4 and then reaches an object lens 5. The object lens 5 focuses the light beam on a data layer 7 of an optical disc 6. The light beam is then reflected back to the pick-up head 1 by the data layer 7 and is refracted to illuminated surfaces A, B, C and D of a photo detector 8 by the optical components 3. The signal processing device 9 generates focusing error (FE) signals according to the signals of the illuminated surfaces (A+C)−(B+D), and further transmits the focusing error signals to a micro-processing device 10, so that an actuator 11 is controlled to drive the object lens 5 to move. Therefore, the light beam is focused on the data layer 7.

According to the specification of the optical disc 6, the data layer 7 is adjacent to an optical disc substrate 12 having a standard thickness d, and is set an optimum SA value corresponding to the optical disc 6. The micro-processing device 10 transmits a control signal to the SA value adjusting device 13 for adjusting the distance between the lenses of the spherical aberration correcting unit 4, so that the projection path of the light beam is changed to improve the focusing quality of the light beam. Thus, the light beam reflected back to the pick-up head 1 through the data layer 7 becomes an optimum signal.

As indicated in FIG. 2, a process diagram of identifying a layer number of an optical disc according to the prior art is shown. Normally, the optimum SA value is set at the first data layer of the blu-ray optical disc near the surface by the blu-ray disk drive. According to the prior art, when the layer number of the blu-ray optical disc is identified, the object lens is moved upward for performing a focusing course P after the pick-up head is lighted up. Therefore, the focus point passes through the optical disc to form focusing error signals. At this time, the magnitudes of the focusing error signals are observed, and a threshold T is set. When the magnitude of the focusing error signals exceeds the threshold T, the counter adds the count by 1.

In terms of a single-layered blu-ray optical disc, when the focus point firstly passes through the surface of the blu-ray optical disc, an S-curved focusing error signal which is within the range formed by the thresholds T and −T is generated. Then, when the focus point passes through the data layer, an S-curved focusing error signal which exceeds the range formed by the thresholds T and −T is generated. As the S-curved focusing error signal exceeds the range formed by the thresholds T and −T twice, the counter adds the count by 2. In terms of a double-layered blu-ray optical disc, when the focus point firstly passes through the surface of the blu-ray optical disc, an S-curved focusing error signal which is within the range formed by the thresholds T and −T is generated. Then, when the focus point passes through the first data layer, an S-curved focusing error signal which exceeds the range formed by the thresholds T and −T is generated. As the S-curved focusing error signal exceeds the range formed by the thresholds T and −T twice, the counter adds the count by 2. The focus point then passes through the second data layer. As the optimum SA value is set on the first data layer of the blu-ray optical disc, the generated S-curved focusing error signal is slight smaller than the S-curved focusing error signal generated when the focus point passes through the first data layer. However, the generated S-curved focusing error signal still exceeds the range formed by the thresholds T and −T twice, so that the total count is 4 as the counter adds the count by 2. Thus, the prior art identifies the layer number of blu-ray optical disc according to the count of the counter.

As the pick-up head is close to the surface of the optical disc during the operation, the surface of the blu-ray optical disc coated with a hard film to avoid the optical disc being scratched by the pick-up head makes the reflectance increase. In addition, as the optimum SA value of the blu-ray optical disc is set on the first data layer which is close to the film surface, the focusing error signals formed by the surface of the blu-ray optical disc is too large and even larger than the focusing error signals of CD and DVD. Moreover, different optical disk drives have individual differences in circuit and gain, and the selected threshold is usually smaller than the focusing error signals generated by the surface of the blu-ray optical disc. Consequently, the layer number may be erroneously identified, the reading/writing of an optical disc may fail, and the function and performance of the optical disk drive are affected. Thus, the generally known optical disk drive still has the problems in identifying the layer number.

### SUMMARY OF THE INVENTION

The present invention is directed to a method for identifying a layer number of an optical disc. An optimum SA value is set on each data layer, and focusing courses are performed to obtain maximum amplitudes of focusing error signals. According to whether the maximum amplitudes of the focusing error signals in the focusing courses are equal, the optical disc is a single-layered disc or a double-layered disc is identified.

According to a first aspect of the present invention, a method for identifying a layer number of an optical disc is provided. The magnitudes of the focusing error signals obtained by the circuit and gain of one optical disk drive are compared, so that the influence on signal comparison due to different characteristics of different optical disk drives can be reduced and it is no need to set a threshold.

According to a second aspect of the present invention, a method for identifying a layer number of an optical disc is provided. A pre-determined range is used for determining whether the maximum amplitudes of the focusing error signals in the focusing courses are equal so as to increase the precision in identification.

In order to have the above features, the present invention provides a method for identifying a layer number of an optical disc. Firstly, a SA value is adjusted to a standard SA value of each of two data layers in sequence. Next, the focus point is enabled to pass through the optical disc for performing focusing courses. Then, the maximum amplitudes of focusing error signals in the focusing courses are recorded. After that, whether the maximum amplitudes of the focusing error signals recorded in the focusing courses are equal is checked. If the maximum amplitudes are equal, the optical disc is identified as a double-layered disc. If the maximum amplitudes are not equal, the optical disc is identified as a single-layered disc.

The present invention provides another method for identifying a layer number of an optical disc. Firstly, a SA value is adjusted to a standard SA value of each of two data layers in sequence. Next, the focus point is enabled to pass through the optical disc for performing focusing courses. Then, the maximum amplitudes of focusing error signals in the focusing courses are recorded. After that, whether the difference between the maximum amplitudes of the focusing error signals recorded in the focusing courses is within a pre-determined range is checked. If the difference is within the pre-determined range, the optical disc is identified as a double-layered disc. If the difference is not within the pre-determined range, the optical disc is identified as a single-layered disc.

The invention will become apparent from the following detailed description of the preferred but non-limiting embodiments. The following description is made with reference to the accompanying drawings.

### BRIEF DESCRIPTION OF THE DRAWINGS

FIG. 1 shows a function block diagram of a spherical aberration correcting system of an optical disk drive according to the prior art.

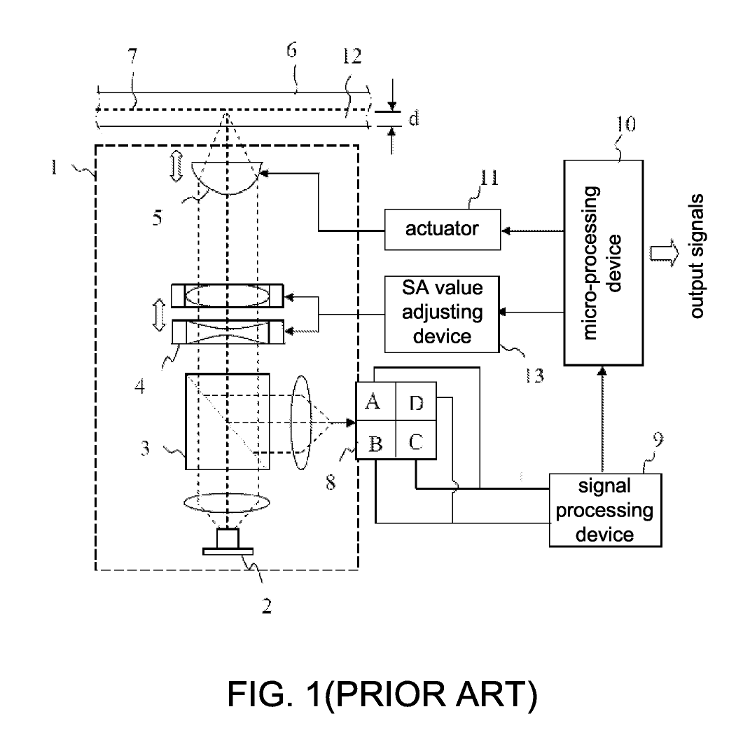

FIG. 2 shows a process diagram of identifying a layer number of an optical disc according to the prior art.

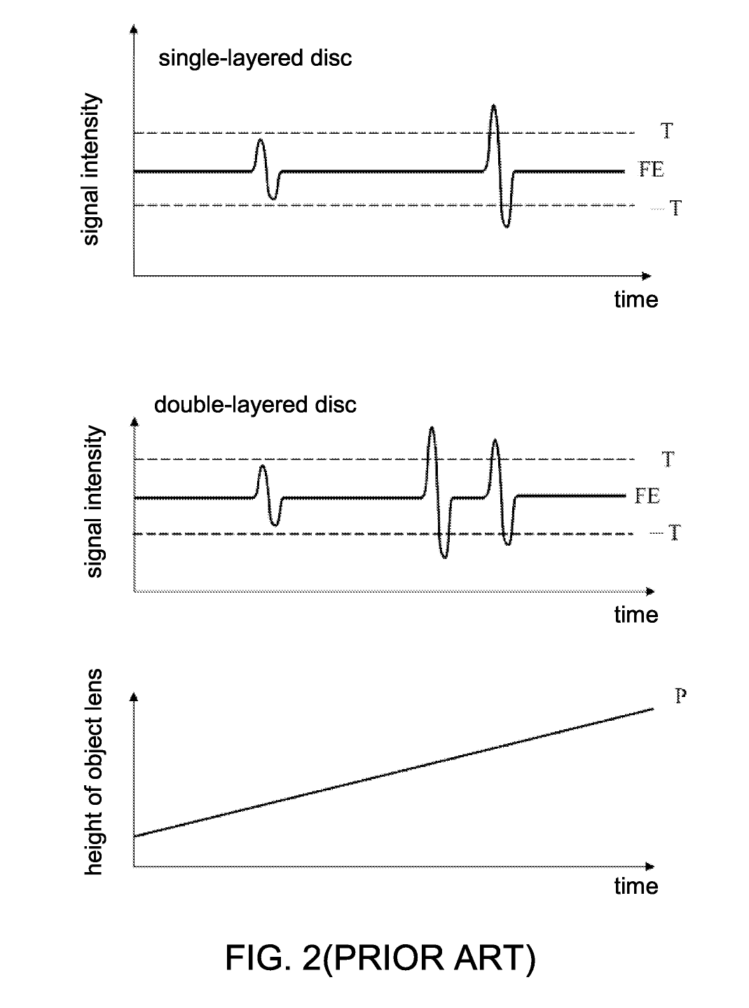

FIG. 3 shows a process diagram of focusing courses for a single-layered disc according to the present invention.

FIG. 4 shows a process diagram of focusing courses for a double-layered disc according to the present invention.

FIG. 5 shows another process diagram of focusing courses for a double-layered disc according to the present invention.

FIG. 6 shows a flowchart for identifying a layer number of an optical disc according to a first embodiment of the present invention.

FIG. 7 shows a flowchart for identifying a layer number of an optical disc according to a second embodiment of the present invention.

### DETAILED DESCRIPTION OF THE INVENTION

In order to have the above features, the technical skills and the effects according to the present invention are disclosed in preferred embodiments below with reference to the accompanying drawings.

According to a method for identifying a layer number of an optical disc disclosed in the present invention, mainly checks whether a standard SA value correspondingly pre-determined is stored in the standard position of data layer as set by an ordinary optical disk drive with respect to various specifications of optical discs. When the optical disk drive determines the data layer in which the reading/writing data is stored, the correspondingly stored standard SA value is used for adjusting the position for the optimum SA compensation to the data layer in which the data is stored. Therefore, the optimum signal quality can be maintained and the obtained signals are the maximum. If the SA value is not set on the data layer in which the reading/writing data is stored, the magnitudes of the signals are reduced. According to the method for identifying the layer number of the optical disc of the present invention, the SA value is adjusted to the standard positions of the first data layer and the second data layer in sequence, focusing courses are respectively performed, and the object lens is moved upward/downward for enabling the focus point to pass through the optical disc for obtaining focusing error signals from a reflective positions such as the surface of the optical disc, the first data layer or the second data layer.

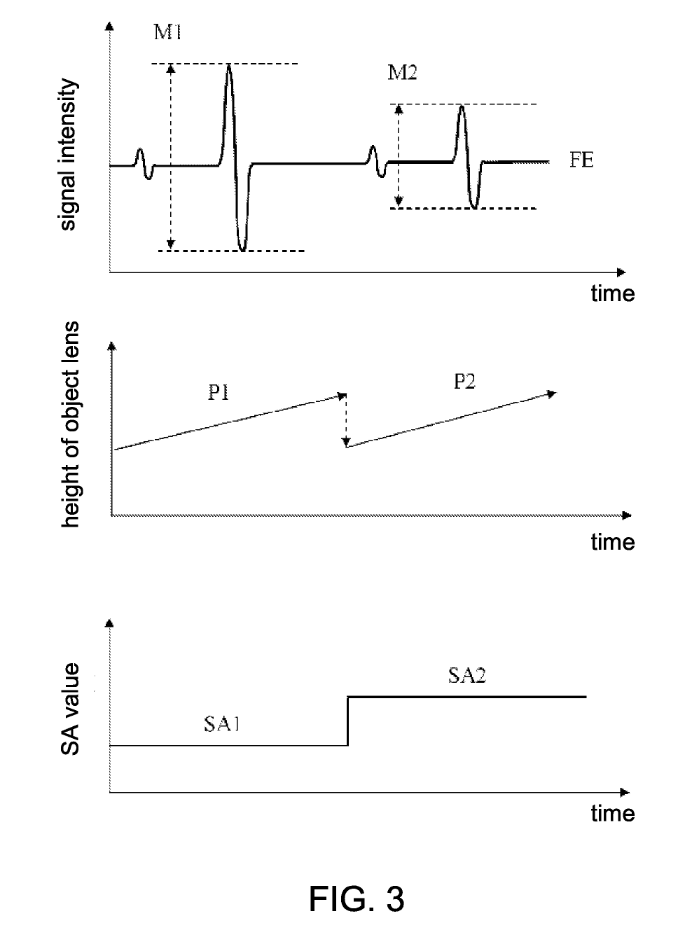

As indicated in FIG. 3, a process diagram of focusing courses for a single-layered disc according to the present invention is shown. In terms of a single-layered disc, when the SA value is adjusted to a standard position SA1 of the first data layer for performing a focusing course P1, the object lens is, for example, moved upward. The focusing error signals whose focus point passes through the surface of the optical disc has small amplitude as the surface reflectance of the surface of the optical disc is small. Then, the focus point passes through the first data layer. As the position for the optimum SA compensation is adjusted to the data layer, the maximum amplitude M1 of the focusing error signal is obtained. After that, the focus point continues to pass through the standard position of the second data layer. As there is no data layer at the standard position of the second data layer, no focusing error signals will be generated. Thus, when the SA value is adjusted to the first data layer of the single-layered disc, the amplitude M1 of the focusing error signals of the first data layer is the maximum.

Then, the object lens is moved downward so as to back to a start point. When the SA value is adjusted to a standard position SA2 of the second data layer for performing a focusing course P2, the object lens is moved upward again. The focusing error signals whose focus point passes through the surface of the optical disc has small amplitude as the surface reflectance of the optical disc is small. After that, the focus point passes through the first data layer. As the position for the optimum SA compensation is not adjusted to the data layer, only ordinary amplitude M2 of the focusing error signal is obtained. When the focus point continues to pass through the standard position of the second data layer, despite the position for the optimum SA compensation is adjusted to the position, no focusing error signal will be generated as there is no data layer at the standard position of the second data layer. Thus, when the SA value is adjusted to the second data layer of the single-layered disc, the amplitude M2 of the focusing error signals of the first data layer is the maximum.

The maximum amplitudes of the focusing error signals respectively obtained from the focusing courses P1 and P2 of the single-layered disc are compared. As the position for the optimum SA compensation is adjusted to the first data layer in the focusing course P1 but not in the focusing course P2, the maximum amplitude M1 of the focusing error signals obtained in the focusing course P1 is obviously larger than the maximum amplitude M2 of the focusing error signals obtained in the focusing course P2. Therefore, the amplitude M1 of the focusing error signals is not equal to the amplitude M2 of the focusing error signals for the single-layered disc.

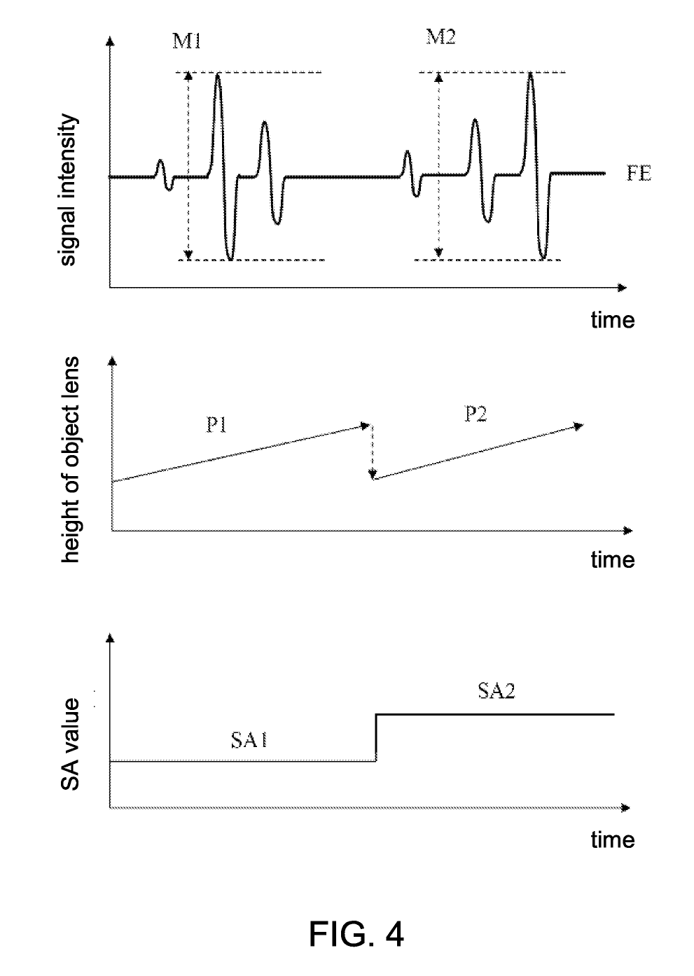

As indicated in FIG. 4, a process diagram of focusing courses for a double-layered disc according to the present invention is shown. In terms of a double-layered disc, when the SA value is adjusted to the standard position SA1 of the first data layer for performing the focusing course P1, the focusing error signals whose focus point passes through the surface of the optical disc has small amplitude as the surface reflectance of the surface of the optical disc is small. Then, the focus point passes through the first data layer. As the position for the optimum SA compensation is adjusted to the data layer, the maximum amplitude M1 of the focusing error signals is obtained. After that, when the focus point continues to pass through the second data layer, the obtained amplitude of the focusing error signals is smaller than the amplitude M1 of the focusing error signals as the position for the optimum SA compensation is not adjusted to the data layer. Thus, when the SA value is adjusted to the first data layer of the double-layered disc, the amplitude M1 of the focusing error signals of the first data layer is the maximum.

Then, when the SA value is adjusted to the standard position SA2 of the second data layer for performing the focusing course P2, the focusing error signals whose focus point passes through the surface of the optical disc has small amplitude as the surface reflectance of the optical disc is small. After that, the focus point passes through the first data layer. As the position for the optimum SA compensation is not adjusted to the data layer, only ordinary amplitude of the focusing error signals is obtained. Then, when the focus point continues to pass through the second data layer, the maximum amplitude M2 of the focusing error signals is obtained as the position for the optimum SA compensation is adjusted to the data layer. Thus, when the SA value is adjusted to the second data layer of the double-layered disc, the amplitude M2 of the focusing error signals of the second data layer is the maximum.

The maximum amplitudes of the focusing error signals respectively obtained from the focusing courses P1 and P2 of the double-layered disc are compared. The amplitude M1 of the focusing error signals obtained in the focusing course P1 is the maximum because the position for the optimum SA compensation is adjusted to the first data layer. The amplitude M2 of the focusing error signals obtained in the focusing course P2 is the maximum because the position for the optimum SA compensation is adjusted to the second data layer. The amplitudes M1 and M2 of the focusing error signals are equal because the amplitudes M1 and M2 of the focusing error signals are obtained as the position for the optimum SA compensation is set at the position that the focus point passes through.

The results obtained from the above focusing courses of the single-layered disc and the double-layered disc are further illustrated as follows. In terms of the single-layered disc, the maximum amplitudes of the focusing error signals can not be obtained in the two focusing courses as the position for the optimum SA compensation is adjusted to the position without any data layer in one of the two focusing courses that the SA value is adjusted. Therefore, the maximum amplitudes of the focusing error signals in the two focusing courses are not equal. On the contrary, in terms of the double-layered disc, the position for the optimum SA compensation is adjusted to the position of the data layer in each of the two focusing courses that the SA value is adjusted, so the maximum amplitudes of the focusing error signal obtained in the two focusing courses are equal. Thus, the layer number of an optical disc can be easily identified according to whether the maximum amplitudes of the focusing error signals obtained in two focusing courses are equal. The optical disc is identified as a double-layered disc if the maximum amplitudes of the focusing error signals are equal and is identified as a single-layered disc if the maximum amplitudes of the focusing error signals are not equal.

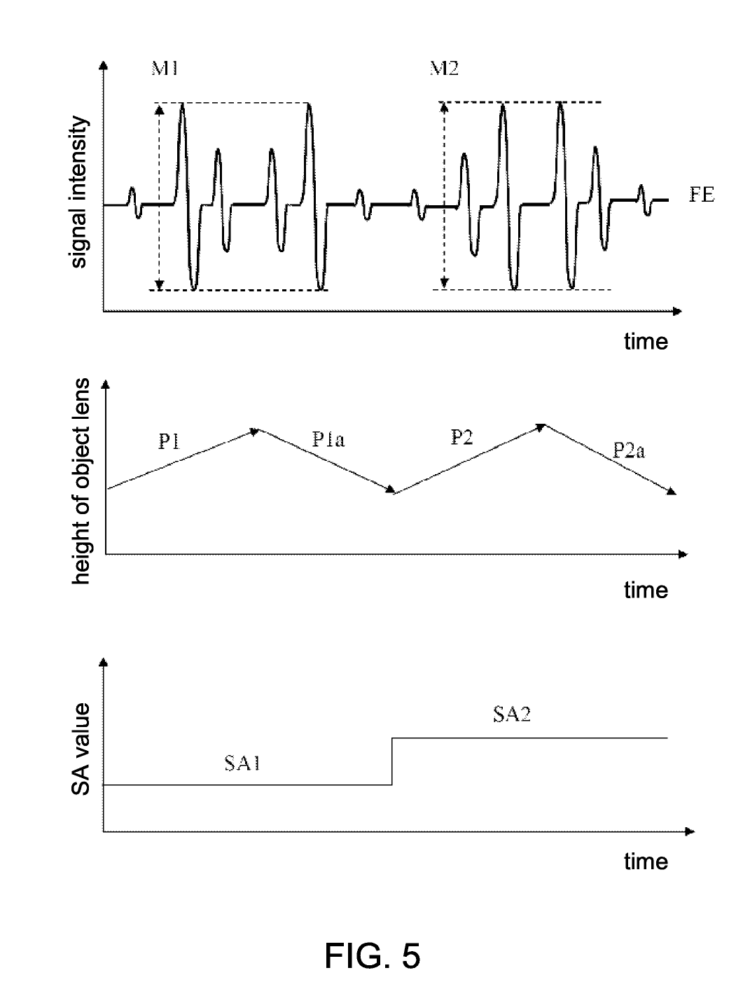

As indicated in FIG. 5, another process diagram of focusing courses for a double-layered disc according to the present invention is shown. In the above embodiment, the SA value is adjusted once for performing one focusing course. However, in order to avoid incorrectly identifying the layer number due to the errors occurring in the single focusing course, more than one focusing course can be performed when the SA value is adjusted. Let two focusing courses performed on a double-layered disc be taken as an example. The focusing courses are basically similar to the above focusing course of the double-layered disc. However, after the object lens is moved upward for performing the focusing course P1, the object lens is immediately moved downward for performing the focusing course P1a with the unchanged SA value. In addition, after the object lens is moved upward for performing the focusing course P2, the object lens is immediately moved downward for performing the focusing course P2a with the unchanged SA value. As the sequence in passing through the data layers in the focusing course P1 is opposite to that in the focusing course P1a, and the sequence in passing through the data layers in the focusing course P2 is opposite to that in the focusing course P2a, the obtained signals have the same magnitude but in opposite sequences. Thus, more signals can be obtained when the object lens is moved back, so that the errors occurring in the single focusing course due to interference can be avoided.

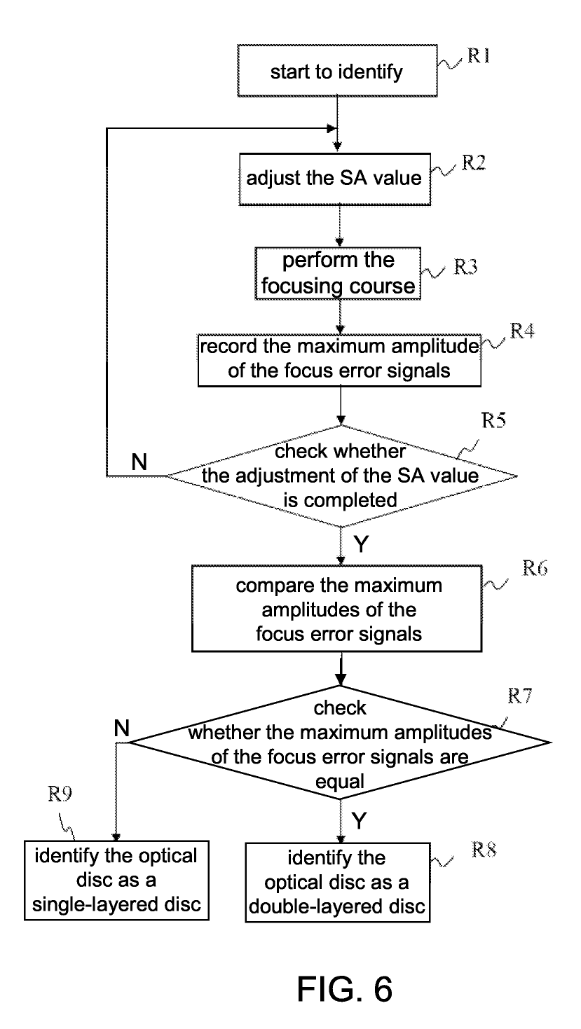

As indicated in FIG. 6, a flowchart for identifying a layer number of an optical disc according to a first embodiment of the present invention is shown. According to the present embodiment of the invention, the SA values of the two data layers are respectively adjusted for performing the focusing courses in sequence. Therefore, the layer number of the optical disc is identified according to whether the maximum amplitudes of the focusing error signals are equal. The detailed steps are disclosed below. In step R1, the pick-up head is lighted up to start to identify the layer number of the optical disc. Next, in step R2, the SA value is adjusted to the standard SA value of one of the two data layers in sequence. Then, in step R3, the object lens is moved for performing the focusing course to obtain focusing error signals. Afterwards, in step R4, the maximum amplitude of the obtained focusing error signals is recorded. After that, in step R5, whether the adjustment of the standard SA value of each data layer is completed is checked. If the adjustment is uncompleted, the method returns to step R2 to adjust the SA value of the other data layer to the standard SA value. If the adjustment is completed, the method proceeds to step R6 to compare the maximum amplitudes recorded in step R4. Then, in step R7, whether the maximum amplitudes of the focusing error signals are equal is checked. If the maximum amplitudes of the focusing error signals are equal, the method proceeds to step R8 to identify the optical disc as a double-layered disc. If the maximum amplitudes of the focusing error signals are not equal, the method proceeds to step R9 to identify the optical disc as a single-layered disc.

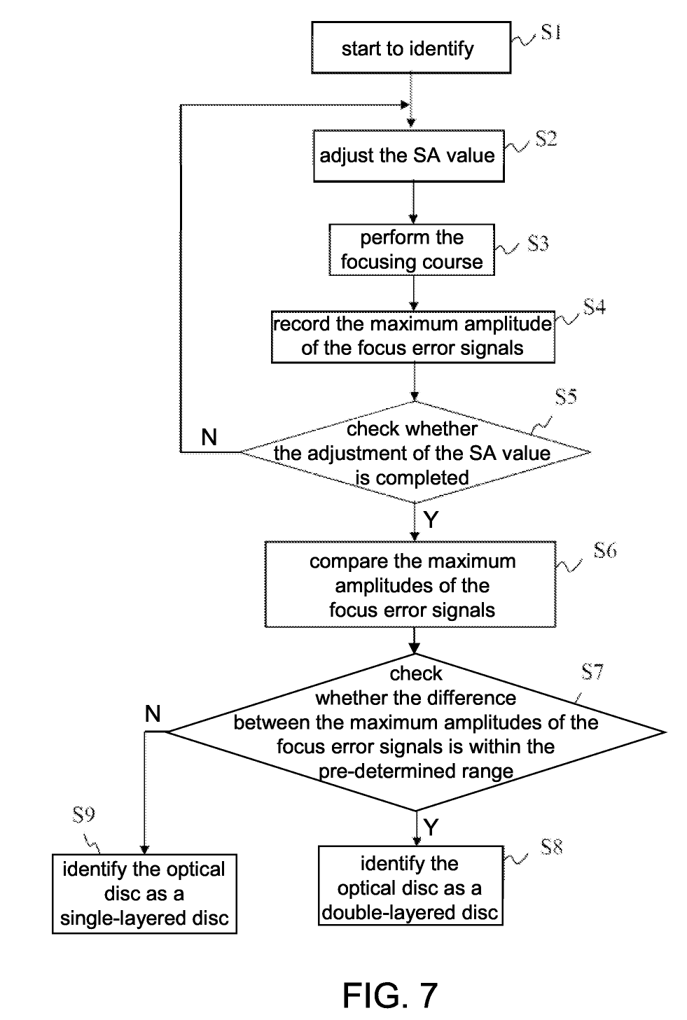

As indicated in FIG. 7, a flowchart for identifying a layer number of an optical disc according to a second embodiment of the present invention is shown. Steps S1 to S9 of the present embodiment of the invention are basically similar to steps R1 to R9 of the first embodiment. The only difference is that identifying the optical disc as a single-layered disc or a double-layered disc is determined according to the maximum amplitudes of the focusing error signals obtained in the focusing courses in the first embodiment. In order to avoid machine error and signal noises, the maximum amplitudes of the focusing error signals with a little difference can be regarded as the same. Therefore, in step S7 of the present embodiment of the invention, a pre-determined range is used for allowing a tolerance in determining whether the maximum amplitudes of the focusing error signals are equal, so that the actual conditions of signals can be considered. More specifically, in step S7 of the present embodiment of the invention, whether the difference between the maximum amplitudes of the focusing error signals is within the pre-determined range is checked. If the difference is within the pre-determined range, the method proceeds to step S8 to identify the optical disc as a double-layered disc. If the difference is not within the pre-determined range, the method proceeds to step S9 to identify the optical disc as a single-layered disc.

According to the method for identifying the layer number of the optical disc disclosed in the above embodiments of the present invention, the SA value of each data layer is adjusted to the optimum SA value for performing the focusing courses, so that the maximum amplitudes of the focusing error signals in the focusing courses are obtained. Thus, the layer number of the optical disc can be easily identified according to whether the maximum amplitudes of the focusing error signals obtained in the focusing courses are equal or their difference is within the pre-determined range. If the maximum amplitudes of the focusing error signals in the focusing courses are equal or their difference is within the pre-determined range, the optical disc is identified as a double-layered disc. If the maximum amplitudes of the focusing error signals in the focusing courses are not equal or their difference is not within the pre-determined range, the optical disc is identified as a single-layered disc. In addition, the magnitudes of the focusing error signals obtained by the circuit and gain of one optical disk drive are compared, so the influence on signal comparison due to different characteristics of different optical disk drives can be reduced and it is no need to set a threshold.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for identifying a layer number of an optical disc adapted to an optical disk drive, wherein the method comprises the steps of:
(1) adjusting a spherical aberration (SA) value to a standard SA value of one of two data layers;
(2) performing a focusing course;
(3) recording a maximum amplitude of focusing error signals in the focusing course;
(4) checking whether the adjustment of the standard SA value of each data layer is completed, wherein if the adjustment is uncompleted, the method returns to step (1), and if the adjustment is completed, the method proceeds to step (5); and
(5) checking whether the maximum amplitudes of the focusing error signals recorded in the focusing courses are equal, wherein if the maximum amplitudes are equal, the optical disc is identified as a double-layered disc, and if the maximum amplitudes are not equal, the optical disc is identified as a single-layered disc.

2. The method for identifying the layer number of the optical disc according to claim 1, wherein the standard SA value is a standard position of the data layer according to various optical disc specifications for testing whether the correspondingly pre-determined standard SA value is stored thereon.

3. The method for identifying the layer number of the optical disc according to claim 1, wherein an object lens of the optical disk drive is moved upward or downward during the focusing course so as to enable the focus point to pass through the optical disc.

4. The method for identifying the layer number of the optical disc according to claim 3, wherein the focusing course comprises moving the object lens of the optical disk drive upward for enabling the focus point to pass through the optical disc, and then moving the object lens of the optical disk drive downward for enabling the focus point to pass through the optical disc.

5. The method for identifying the layer number of the optical disc according to claim 3, wherein when the adjustment of the standard SA value of each data layer is determined to be uncompleted in step (4), the object lens of the optical disk drive is moved to a start point firstly before the method returns to step (1).

6. A method for identifying a layer number of an optical disc adapted to an optical disk drive, wherein the method comprises the steps of:
(1) adjusting a spherical aberration (SA) value to a standard SA value of one of two data layers;
(2) performing a focusing course;
(3) recording a maximum amplitude of focusing error signals in the focusing course;
(4) checking whether the adjustment of the standard SA value of each data layer is completed, wherein if the adjustment is uncompleted, the method returns to step (1), and if the adjustment is completed, the method proceeds to step (5); and
(5) checking whether the difference between the maximum amplitudes of the focusing error signals recorded in the focusing courses is within a pre-determined range, wherein if the difference is within the pre-determined range, the optical disc is identified as a double-layered disc, and if the difference is not within the pre-determined range, the optical disc is identified as a single-layered disc.

7. The method for identifying the layer number of the optical disc according to claim 6, wherein the standard SA value is a standard position of the data layer according to various optical disc specifications for testing whether the correspondingly pre-determined standard SA value is stored thereon.

8. The method for identifying the layer number of the optical disc according to claim 6, wherein an object lens of the optical disk drive is moved upward or downward during the focusing course so as to enable the focus point to pass through the optical disc.

9. The method for identifying the layer number of the optical disc according to claim 8, wherein the focusing course comprises moving the object lens of the optical disk drive upward for enabling the focus point to pass through the optical disc, and then moving the object lens of the optical disk drive downward for enabling the focus point to pass through the optical disc.
